(19) United States
(12) Patent Application Publication
(10) Pub. No.: US 2009/0094539 A1
(43) Pub. Date: Apr. 9, 2009

(54) CONTROLLING A COMPUTER PERIPHERAL DEVICE USING A UNIVERSAL DRIVER AND DEVICE-GENERATED USER INTERFACE INFORMATION

(76) Inventors: Yao-Tian Wang, Sunnyvale, CA (US); Yue Liu, San Jose, CA (US); Hitoshi Sekine, Los Altos, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/846,869

(22) Filed: Aug. 29, 2007

(51) Int. Cl. G06F 3/048

(52) U.S. Cl. 715/762

(57) ABSTRACT

In an embodiment, a computer peripheral device driver comprises logic operable to perform sending, from a computer to a peripheral device, a request for a user interface of the peripheral device; receiving from the peripheral device a description of the user interface that the peripheral device has created in at a time of the request and based upon then-current capabilities of the peripheral device; creating one or more graphical user interface (GUI) elements based upon the description of the user interface and causing displaying the GUI elements; receiving user input representing one or more selections of the GUI elements; creating a user interface ticket that describes the GUI elements that were selected as represented in the user input; sending the user interface ticket to the peripheral device.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer peripheral device drivers.

### BACKGROUND

Peripheral devices can be coupled to computers. Application programs running on computers normally control the peripheral devices through device drivers, and a different specific device driver is used for each different kind of peripheral device. The device drivers typically are specific to the device type, device model, the processor and operating system (platform) on which the device driver is running, and sometimes even to the type of data that the platform generates.

In a typical approach, to set up job-related settings for a particular job relating to a particular peripheral device, an application invokes the device driver and displays a static user interface through which the user can select various parameter values or other job settings. The driver interprets the selections and transforms the selections into a set of job setting data. The driver sends the job setting data to the device, either bundled with substantive job data or separately using a data structure or message termed a “job ticket.”

Development of conventional device drivers is complex. A device manufacturer normally is required to devote substantial resources to develop a wide array of drivers to account for every permutation of devices made by the manufacturer and target computer platforms. Further, the user interface provided by a device driver is normally static and fixed, so that if the device is upgraded with a new feature, the manufacturer also must update the driver to present the new feature in an updated user interface.

In one approach, a printer is coupled to a network and the printer comprises a Web server. The printer stores HTML documents that comprise a user interface of the printer; the user interface resembles a control panel for the printer. A user may activate a browser application, connect to a URL of an HTML document comprising the user interface, receive the HTML document from the Web server in the printer, and display the HTML document in the browser. The user can interact with the HTML document using the browser to configure the printer or perform control functions. In this approach, the browser application is not involved in creating job data for printing or other purposes.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY

In an embodiment, a computer peripheral device driver comprises logic operable to perform sending, from a computer to a peripheral device, a request for a user interface of the peripheral device; receiving from the peripheral device a description of the user interface that the peripheral device has created in at a time of the request and based upon then-current capabilities of the peripheral device; creating one or more graphical user interface (GUI) elements based upon the description of the user interface and causing displaying the GUI elements; receiving user input representing one or more selections of the GUI elements; creating a user interface ticket that describes the GUI elements that were selected as represented in the user input; sending the user interface ticket to the peripheral device.

In an embodiment, the peripheral device driver further comprises logic which when executed causes generating and displaying a list of a plurality of available peripheral devices, receiving second user input representing a selection of one of the available peripheral devices, and sending the request to the selected one of the available peripheral devices represented in the second user input.

In an embodiment, the peripheral device driver further comprises logic which when executed causes sending to the peripheral device a list of one or more user interface formats that the peripheral device driver may support, and receiving from the peripheral device information identifying a selected one of the user interface formats that the peripheral device supports.

In an embodiment, the peripheral device driver further comprises logic which when executed causes receiving from the peripheral device the description of the user interface in any of an extensible markup language (XML) stream or file, an image file, an XML stream or file that wraps an image file, or an XML stream or file that references an image file and comprises additional metadata about the image file. In an embodiment, the description of the user interface comprises an image map and wherein the user interface ticket comprises one or more sets of coordinates.

In an embodiment, the peripheral device driver further comprises logic which when executed causes receiving, from the peripheral device, information identifying a user interface format that the peripheral device supports, and storing the information in an entry of a table that associates the information with a copy of the description of the user interface in association with an identifier of the peripheral device.

In an embodiment, the peripheral device driver further comprises logic which when executed causes performing, only when a time value of the entry of the table has expired, sending to the peripheral device a request for a new user interface description.

In an embodiment, the peripheral device driver further comprises logic which when executed causes sending to the peripheral device, separately from the user interface ticket, job data of an application program.

In an embodiment, the peripheral device comprises any of a printer, a multifunction printing device, a scanner, or a finishing machine.

In an embodiment, the peripheral device driver further comprises logic which when executed causes performing sending, to the peripheral device, a second request for the user interface of the peripheral device; receiving from the peripheral device a second description of the user interface that the peripheral device has created in at a second time of the second request and based upon then-current capabilities of the peripheral device, wherein the second description describes a new graphical user interface element for a changed feature of the peripheral device; creating one or more second graphical user interface (GUI) elements based upon the second description of the user interface and causing displaying the second GUI elements. The second UI may be generated in response to a first user selection on the first UI, or the second UI may be generated because of a changed feature of the peripheral device.

In an embodiment, the description of the user interface comprises a first image map, further comprising logic which when executed causes performing: receiving from the peripheral device a second image map that the peripheral device has created in response to receiving the user interface ticket; causing displaying the second image map; receiving second user input representing one or more second selections in the second image map; creating a second user interface ticket that describes the second selections; sending the second user interface ticket to the peripheral device.

Other embodiments encompass a computer-implemented method and an apparatus configured according to the steps described above.

### BRIEF DESCRIPTION OF THE DRAWINGS

In the drawings:

FIG. 1 illustrates an example computing system in which a universal device driver may be used.

FIG. 2 illustrates data communicated between the universal device driver and the peripheral device of FIG. 1.

FIG. 3 illustrates an example process of operating a universal device driver.

FIG. 4 illustrates an example process of printing a job using a universal device driver, a user interface description, and a user interface ticket.

FIG. 5 illustrates an example image map comprising a user interface for a peripheral device.

FIG. 6 illustrates an example process of printing a job using a universal device driver and an image map of a user interface.

FIG. 7 illustrates example successive screen displays that may be generated during user interaction with a universal device driver.

FIG. 8A illustrates an example image map of user interface selection regions.

FIG. 8B illustrates an example image map of a user interface for a peripheral device.

FIG. 9 is a block diagram that illustrates a computer system 900 upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1.0 Structural and Functional Overview

In an embodiment, a computer peripheral device generates a dynamic user interface for job control purposes and communicates the user interface to a device driver at a host computer. The driver displays the user interface and receives user input data representing one or more selections in the user interface. The driver does not interpret the user input data into job setting data. Instead, the driver sends the user input data to the peripheral device in a message that identifies the user input data as user interface selections. The message may comprise a user interface ticket. In response, the peripheral device interprets the user interface selections into job settings, and applies the job settings appropriately.

In an embodiment, the driver and the peripheral device communicate using a protocol such as Web Services. Optionally, the driver and the peripheral device perform a handshake communication to establish a format in which the peripheral device should send the user interface description to the driver. Example formats include an image map, an XML document such as an XUL document, HTML, and others, and embodiments are not limited to any particular manner of encoding a user interface description. The peripheral device constructs and transmits user interface data to the driver, which interprets the user interface data and generates a visual display on the host computer.

In an embodiment, the format of the user interface ticket that is sent from the driver to the peripheral device depends on the original format of the user interface description. For example, if the format of the user interface description was an image map, the driver returns a series of {X, Y} coordinates corresponding to the location on the image map at which the user performed a selection. Alternatively, if the user interface description is an XML document, then the device driver may transmit back a series of XML elements that represent user interface widgets that the user operated. The XML communication may occur in a data stream.

The driver may send to the peripheral device a series of user interface tickets that together comprise a complete user selection of multiple settings for a particular job. Alternatively, the driver may send to the peripheral device one user interface ticket comprising all the user interface selections that the user made, in one transmission. For example, the user interface ticket may comprise an XML document or stream that contains all element names of the original XML user interface description that the user selected or operated. In the first alternative, the peripheral device may track the series of user interface tickets in a data structure or database, and associate all of the tickets with the particular job. Optionally, the peripheral device may update the user interface after receiving each user interface ticket.

In an embodiment, when a device driver implements the techniques herein, an application program communicates with the device driver in the same manner as the application program communications with a conventional device driver. Thus, no change in the application program is needed to use a device driver that implements the techniques herein.

A user interface for a peripheral device is generated from the device, which understands its own features and can generate the most appropriate and up-to-date user interface. If a manufacturer adds a new feature to the peripheral device, then a new user interface can be generated without any changes to the driver.

In an embodiment, a single driver can operate with all devices that can describe their own user interface in a manner that the driver understands. Therefore, a single driver can work with multiple peripheral devices and there is no need to write a large array of drivers for every permutation of peripheral device and computer platform. The driver does not interpret the user interface elements into job settings; instead, the peripheral device determines the job settings that are needed based on receiving information about selected user interface settings.

In an embodiment, job data is separable from user interface data. The driver sends a user interface ticket to the peripheral device, but the driver does not need to send a job ticket with job data to the device.

Embodiments are operable in environments in which job data is defined separately from job settings. For example, in a printing system, an application program, device driver, and printer device can generate and consume job data independently of job setting data. In an embodiment, Web Service printing methods are used. The application program and driver send the printer a PrintTicket message or JobTicket message separately from a job data package and the printer device processes the two parts separately and applies the settings in the PrintTicket while generating the print output from the job data.

2.0 Example of Implementation

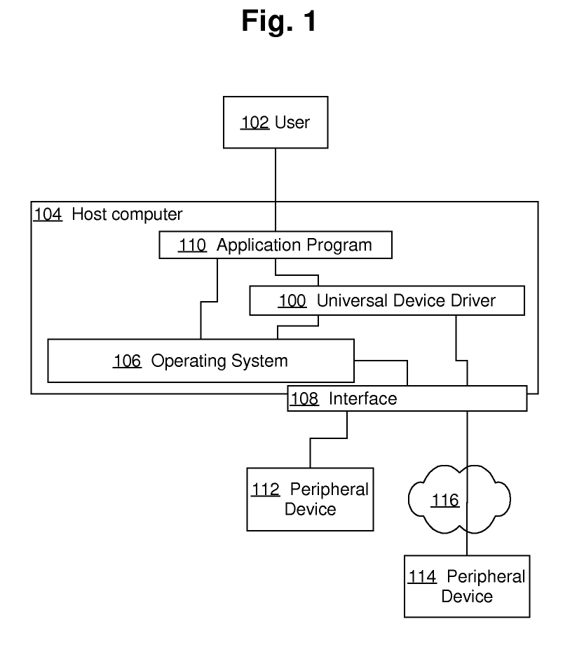

FIG. 1 illustrates an example computing system in which a universal device driver may be used. In an embodiment, a user 102 interacts with a host computer 104, which may comprise a personal computer, workstation, server, wireless computing device, or any other form of host computer. The host computer 104 comprises an operating system 106 that hosts and controls an application program 110 and universal device driver 100. The host computer further comprises an interface 108 that is coupled, directly or indirectly through one or more networks 116, to one or more peripheral devices 112, 114.

Examples of operating system 106 include LINUX, UNIX, MACOS, and MICROSOFT WINDOWS. The application program 110 may comprise any computer program that can perform useful operations in connection with the peripheral devices 112, 114. Examples of application program 110 include a word processor, a spreadsheet, an e-mail client, and a database client.

Interface 108 may comprise any hardware, firmware, software, or combination that can communicate data between the host computer 104 and the peripheral devices 112, 114 and network 116. Examples of interface 108 include a network interface card (NIC) comprising an Ethernet interface, Universal Serial Bus (USB) interface, serial interface, IEEE 1394 (FIREWIRE) interface, and parallel port. Proprietary data communications interfaces also may be used and embodiments do not require standards-based interfaces.

Embodiments may be used with any kind of computer peripheral device. Examples of peripheral devices 112, 114 with which embodiments may be used include printers, scanners, multifunction printers, finishing devices, storage systems, etc. FIG. 1 illustrates two (2) peripheral devices 112, 114 solely to show a clear example and embodiments may operate with any number of peripheral devices that are different or the same.

The universal device driver 100 comprises one or more stored sequences of instructions, or other software elements, that implement the functions described herein. In general, the universal device driver 100 can receive function calls from the operating system 106 or application program 110, and can interact with any of the peripheral devices 112, 114 to cause the peripheral devices to perform a job that the application program initiates. The universal device driver 100 also may be termed a “generic” device driver because the driver can operate with any peripheral device that can provide a description of its user interface as further described herein. The universal device driver 100 may be integrated into operating system 106, application program 110, or other software elements or firmware elements of host computer 104, and embodiments do not require implementing the universal device driver as a standalone software element.

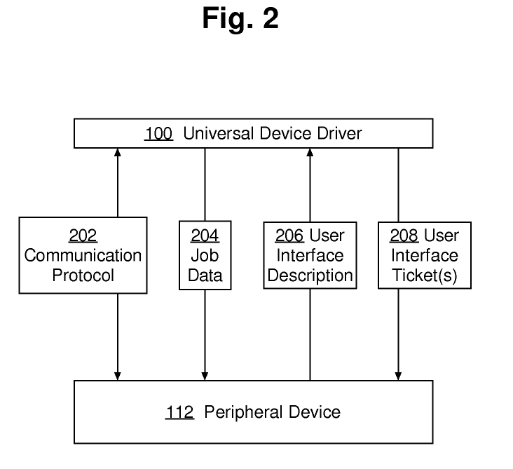

FIG. 2 illustrates data communicated between the universal device driver and the peripheral device of FIG. 1. Various embodiments may communicate the data items shown in FIG. 2 in any order and the reference numerals and positions of the data items in FIG. 2 do not imply a particular order. In an embodiment, universal device driver 100 communicates data to and from the peripheral devices 112, 114 using any form of basic application-layer communication protocol 202 that both the universal device driver and the peripheral devices can support. FIG. 2 shows one peripheral device 112 to illustrate a clear example, but the communications of FIG. 2 may occur between the universal device driver 100 and any peripheral device with which it operates.

In one embodiment, protocol 202 comprises Web Services and each of the universal device driver 100 and the peripheral device 112 implement Web Services functions. For example, each of the device driver 100 and the peripheral device 112 may comprise Web Services logic that can generate application-layer messages according to the Web Services standards of the OASIS consortium or published draft Web Services specifications, and that can interpret and act upon such messages.

In an embodiment, universal device driver 100 also communicates job data 204 to the peripheral device 112. Job data 204 comprises substantive information of a job that the peripheral device 112 is to perform. For example, when the peripheral device 112 is a printer, job data 204 may comprise data in Page Description Language (PDL), or PostScript, that describes a printable document or image.

In an embodiment, peripheral device 112 also communicates to universal device driver 100 one or more sets of data comprising a user interface description 206. The user interface description 206 may be expressed in various formats, methods and mechanisms. Examples of user interface description 206 that may be used in various embodiments include XML, graphical bitmap images, XML-based representations of 3D graphical user interfaces, other XML representations, Scalable Vector Graphics (SVG) documents, HTML, and any other graphical representation such as sprites, textures, etc. Various XML-based user interface descriptors may be used including XUL and UIML. Embodiments are not limited to XML or any other specific method or mechanism for describing a user interface.

Thus, the representation of a graphical user interface (GUI) for a peripheral device, in user interface description 206, is separate from the job data 204.

In an embodiment, universal device driver 100 also communicates one or more user interface tickets 208 to the peripheral device 112. Generally, user interface tickets comprise data that informs the peripheral device 112 about selections that a user has made in a user interface of the peripheral device. For example, user interface tickets 208 may identify GUI elements, coordinates of mouse clicks by the user, or other selection data. In various embodiments, user interface tickets may be expressed in XML, in the format of Web Services tickets, sets of name-value pairs, or in other descriptive text or data.

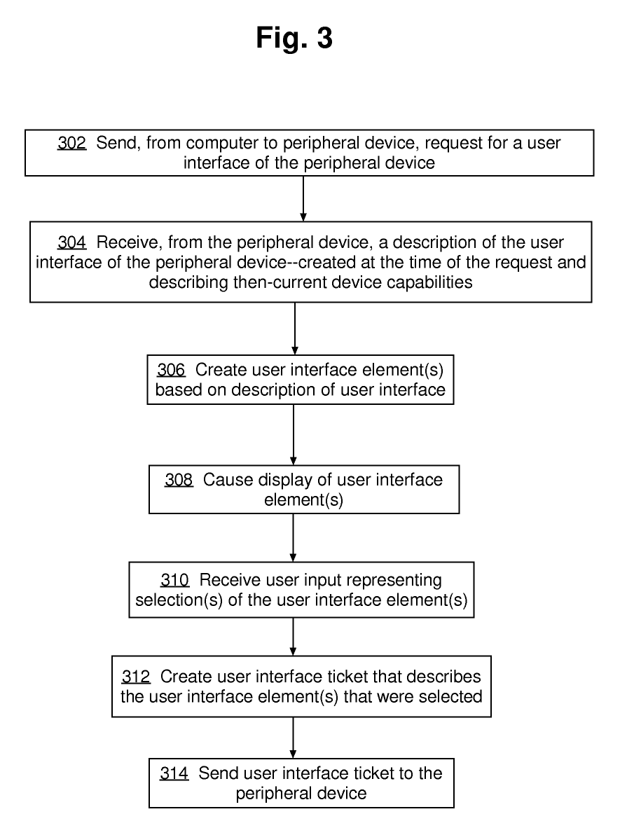

FIG. 3 illustrates an example process of operating a universal device driver. Step 302 comprises sending, from a computer to a peripheral device, a request for a user interface of the peripheral device. In an embodiment, a device driver sends a request to a peripheral device asking the peripheral device to respond with a description of a user interface for interacting with the peripheral device. The user interface may be a graphical user interface, but use of a GUI is not required. Generally, all steps of FIG. 3 state functions that the device driver performs.

Step 304 comprises receiving from the peripheral device a description of the user interface that the peripheral device has created in at a time of the request and based upon then-current capabilities of the peripheral device. In an embodiment, the device replies to the request of step 302 by providing a description of a user interface that enables a user to interact with the device to set job settings or other parameters. If the device was recently updated with new capabilities, the new capabilities are reflected in the user interface description.

For example, in an embodiment, the approach of FIG. 3 further comprises sending, from the computer to the peripheral device, a second request for the user interface of the peripheral device, and receiving from the peripheral device a second description of the user interface that the peripheral device has created in at a second time of the second request and based upon then-current capabilities of the peripheral device. The second description describes a new graphical user interface element for a changed feature of the peripheral device. One or more second user interface elements are then created based upon the second description of the user interface and the process causes displaying the second UI elements.

In one embodiment, Web Services logic in the device processes the request and generates the reply.

Step 306 comprises creating one or more user interface elements based upon the description of the user interface. In an embodiment, the device driver forms a user interface based upon the description. The device driver may call user interface primitives of the operating system or adjunct functional elements, such as dynamic linked libraries, to form the user interface. Step 308 comprises causing displaying the UI elements. In an embodiment, the device driver causes the operating system or other functional elements to display the user interface on a display device of the host computer.

Step 310 comprises receiving user input representing one or more selections of the user interface elements. In an embodiment, a user selects parameter settings, job settings or other elements of the displayed user interface using a keyboard, pointing device, or other data input device of the host computer. Interfaces of the host computer receive signals representing the selections and convey the signals to the operating system. The operating system provides data associated with the selections to the device driver.

Step 312 comprises creating a user interface ticket that describes the user interface elements that were selected as represented in the user input. In an embodiment, the device driver forms a user interface ticket based on the user selections. The user interface ticket comprises a structured language description of the user selections, a set of coordinates identifying positions of the user selections in the user interface, or another form of describing the user selections.

Step 314 comprises sending the user interface ticket to the peripheral device.

In an embodiment, the approach of FIG. 3 further comprises sending to the peripheral device, separately from the user interface ticket, job data of an application program. In an embodiment, after step 314, the peripheral device receives and interprets the user interface ticket, receives job data from a user application, and performs the requested job. The job data may be received at any time before or after the user interface ticket is received at the peripheral device.

In an embodiment, the approach of FIG. 3 further comprises, before step 302, generating and displaying a list of a plurality of available peripheral devices, receiving second user input representing a selection of one of the available peripheral devices, and sending the request to the selected one of the available peripheral devices represented in the second user input.

In an embodiment, the approach of FIG. 3 further comprises, before step 302, sending to the peripheral device a list of one or more user interface formats that the peripheral device driver may support, and receiving from the peripheral device information identifying a selected one of the user interface formats that the peripheral device supports.

In an embodiment, step 304 comprises receiving from the peripheral device the description of the user interface in any of an extensible markup language (XML) stream or file, an image file, an XML stream or file that wraps an image file, or an XML stream or file that references an image file and comprises additional metadata about the image file.

In an embodiment, the approach of FIG. 3 further comprises receiving, from the peripheral device, information identifying a user interface format that the peripheral device may support, and storing the information in an entry of a table that associates the information with a copy of the description of the user interface in association with an identifier of the peripheral device. This step may be performed before step 302 or as part of steps 302, 304.

In an embodiment, the approach of FIG. 3 further comprises performing, only when a time value of the entry has expired, sending to the peripheral device a list of one or more user interface formats that the peripheral device driver supports, and receiving from the peripheral device information identifying a selected one of the user interface formats that the peripheral device also supports.

In various embodiments, the peripheral device used in FIG. 3 comprises any of a printer, a multifunction printing device, a scanner, or a finishing machine. In an embodiment, the description of the user interface comprises an image map and the user interface ticket comprises one or more sets of coordinates.

In an embodiment, the description of the user interface comprises a first image map, and the approach of FIG. 3 further comprises receiving from the peripheral device a second image map that the peripheral device has created in response to receiving the user interface ticket. The process then causes displaying the second image map. Second user input representing one or more second selections in the second image map is received. A user interface ticket that describes the second selections is created and sent to the peripheral device.

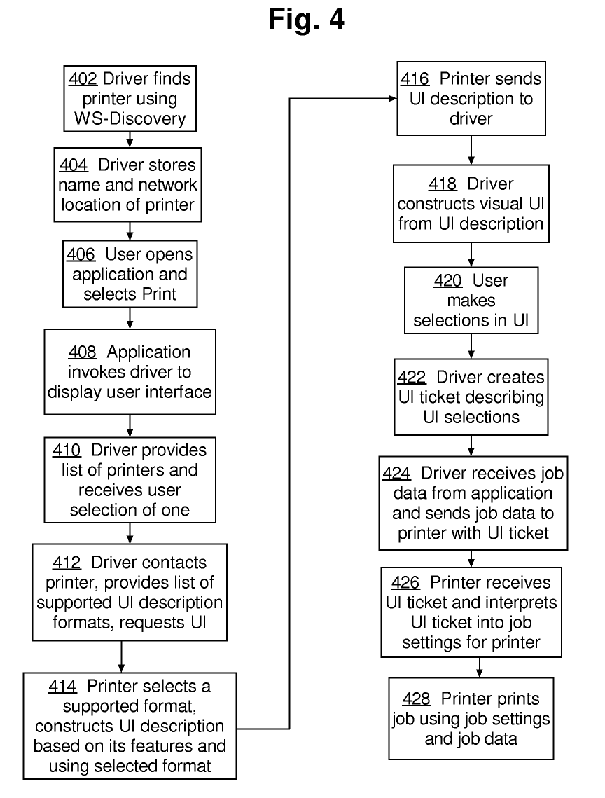

FIG. 4 illustrates an example process of printing a job using a universal device driver, a user interface description, and a user interface ticket. In the example of FIG. 4, the peripheral device is a printer that communicates with the driver using Web Services, and the user interface description format is XML.

In step 402, the driver finds the printer coupled to the host computer or within a network. In one embodiment, a network-enabled discovery protocol is used, such as the WS-Discovery method of the Web Services protocol. In step 404, the driver stores the name and network location of the printer in local storage; step 404 may serve as a printer “installation” step. The network location may comprise an IP address and port number, or other identifying data.

In step 406, a user opens an application and selects a Print function to cause printing of specified data or images. In response, in step 408 the application invokes the universal device driver described herein and requests the driver to display a user interface for printing.

In step 410, the driver optionally provides a list of printers, and receives a user selection of one of the printers. Alternatively, the driver may internally select or use a default printer. Step 410 is optional. In an embodiment, step 410 may be integrated into step 408 and instead of the driver generating a list of printers, the process may provide a list of printers.

In step 412 the driver contacts the selected printer or the default printer, provides a list of supported UI description formats, and requests UI information from the printer. For example, step 412 may comprise sending a Web Services message to a Web Services module of the printer, where the message identifies bitmap and XML as supported description formats and requests a UI of the printer.

In step 414, the printer selects one of the user interface description formats that the printer can support, and creates a UI description based on its features and using the selected format. For example, the printer might select XML as a supported user interface description and create a UI description as an XML document. TABLE 1 is an example UI description expressed in XML:

TABLE 1
EXAMPLE UI DESCRIPTION IN XML

<UI>

<background type= “img”> http://IP/img/UI_background.jpg
</background>
<logo> .... </logo>
<button>

<name> Print </name>
<location> X, Y </location>
<color> indigo </color>
<size> standard </size>
...

</button>
...

</UI>

In step 416, the printer sends the UI description to the driver. In an embodiment, UI descriptions and preferred format information may be stored in local storage of the device driver, such as in a cache. The use of a cache may allow the device driver to omit, in step 412, the list of supported UI description formats and in some cases may permit the process to omit steps 412, 414, 416 entirely. For example, if a cache of the device driver holds current information describing a user interface of the peripheral device, then the device driver can retrieve the information from the cache, skip steps 412, 414, 416, and construct a user interface at step 418 based on the information retrieved from the cache.

The term “cache” as used herein includes any data structure that can store information identifying a peripheral device, a preferred UI ticket format, user interface description data or a UI image, and a time value indicating whether the other data is “fresh.” When an entry expires based on the time value, a refresh of the cached UI may be performed, and the steps involved in negotiating the UI format that is supported may be repeated. A lookup table, database, or other data storage may be used. In one embodiment, an example table comprises:

| | | | | | |
|---|---|---|---|---|---|
| Name | IP Address | Port | Preferred UI | Cached Version | Timeout |
| | | | Ticket Format | of UI | |

In step 418, the driver constructs data for a displayable user interface based on the UI description that it received. Step 418 may comprise interpreting or rendering the XML document into one or more GUI widgets. The driver may interact with the operating system or adjunct functional elements to render the user interface. Alternatively, as further described below, if the peripheral device provides the user interface as an image map, bitmapped image, or other graphics file, then the driver causes the image to be displayed and no rendering or interpreting is needed.

In step 420, the user makes one or more selections in the user interface. If the user makes multiple selections, then the device driver may locally store information about all the user selections.

In step 422, the driver creates a UI ticket describing the UI selections that were made. For example, the UI ticket may comprise an XML document, HTML, other structured text, etc. The UI ticket can be expressed in a canonical format; the format does not depend upon the peripheral device that is being used. The UI ticket identifies all UI selections that the user made, but need not carry any semantic meaning. For example, if a UI comprises a Manual Feed option to cause printing a document from paper that is manually fed into the printer, and the option is shown in a Manual Feed button that is defined in an XML element “MFeed” in the UI description, then the UI ticket can indicate that MFeed was selected without also providing a description of manual feeding. It is sufficient to indicate what button was selected regardless of the meaning of that selection.

Table 2 is an example UI ticket that could be generated in XML based on the UI description of Table 1.

TABLE 2
EXAMPLE UI TICKET IN XML

<UITicket>

<button name = “Print” >

<state> Clicked </state>

</button>
<radiobutton name = “Current Page” >
...
</radiobutton>
<textfield> ...
...

</UITicket>

In an embodiment, the XML documents of Table 1 and Table 2 may be defined in an XML schema that conforms to an existing specification such as XUL or UIML.

In step 424, the driver receives job data from the application and sends the job data to the printer with the UI ticket. The job data and UI ticket may be sent in the same message or different messages. The job data may comprise actual page data to be printed.

In step 426, the printer receives the UI ticket and interprets the UI ticket into job settings for the printer. For example, if the UI ticket indicates that BUTTON2 was selected, then the printer determines that the selection is requesting the manual paper input source. In step 428, the printer prints the job using the job settings that were interpreted and using the job data that was received through step 424.

One result of this approach is that the universal device driver does not have to embody specific features and capabilities of every peripheral device with which the driver is used. Further, when a peripheral device is updated with new features, the universal device driver does not require updating, because all features and the associated user interface are supplied to the driver by the peripheral device.

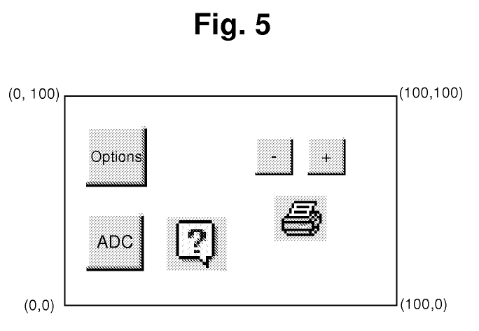

The example of FIG. 4 assumes that a user interface description is expressed in a structured text form such as XML. However, other embodiments may use other methods to describe a user interface of a peripheral device. FIG. 5 illustrates an example image map comprising a user interface for a peripheral device. The image map 502 is a digital graphic image having dimensions of 100 pixels by 100 pixels.

FIG. 5 shows coordinate values for corners of the graphic image. The image map 502 comprises a plurality of buttons and other UI widgets that are displayed as part of the graphic image. One example data representation of the image map 502 is a Windows Bitmap (BMP) file. Other embodiments may use files in the formats of the Joint Photographic Experts Group (JPEG), Graphics Interchange Format (GIF), or other formats.

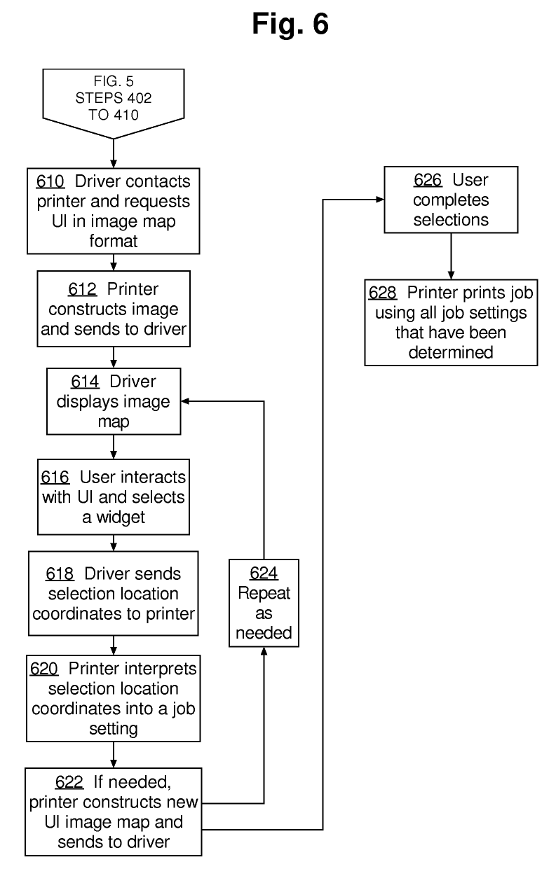

FIG. 6 illustrates an example process of printing a job using a universal device driver and an image map of a user interface. Generally, in the process of FIG. 6, the driver returns the location of each user selection or “click” expressed as an {x, y} coordinate value. For example, using the image map 502 of FIG. 5, the value {80, 20} may represent a selection of a point within the PRINT button at which a user clicked.

The approach of FIG. 6 begins using steps 402 to 410 of FIG. 5, as described above. Thereafter, at step 610, the driver contacts the printer and requests the printer to provide its user interface in image map format. In step 612, the printer constructs an image and sends the image to the driver. The image may comprise an image file in any of the formats identified above. Step 612 may comprise the printer retrieving a stored image from storage in the printer and providing the retrieved image to the driver.

In step 614, the driver causes the received image map to be displayed on a display device of the host computer. In step 616, the user interacts with the user interface represented in the image map and selects a particular widget or element of the user interface. In response, in step 618 the driver sends to the printer the coordinates of the location that the user selected.

In step 620, the printer locally interprets the location coordinates and determines a job setting that the user selection represents. Step 620 may comprise using a local look-up table to map received {X, Y} coordinate values to selections of specific job settings or functions.

If necessary depending on the user's selection, in step 622 the printer constructs a new image map and sends the new image map to the driver. Steps 614 to 622 may be repeated as needed to complete interaction with a user, as indicated in step 624. For example, repetition of the steps is appropriate in a case in which a user selects a pull-down menu from the user interface; in response, the new image map may display the choices of the pull-down menu. Thus, successively received different image maps would display successive states of the user interface as the user interacts with the user interface. Any other useful refreshing of the user interface may be accomplished by repeatedly generating new image maps at the printer and sending the new image maps to the driver for display at the host computer.

Step 626 represents a user completing interaction with the user interface after making all desired selections. In step 628, the printer prints the job using the entire job settings that have been determined at step 620 based on the user interaction.

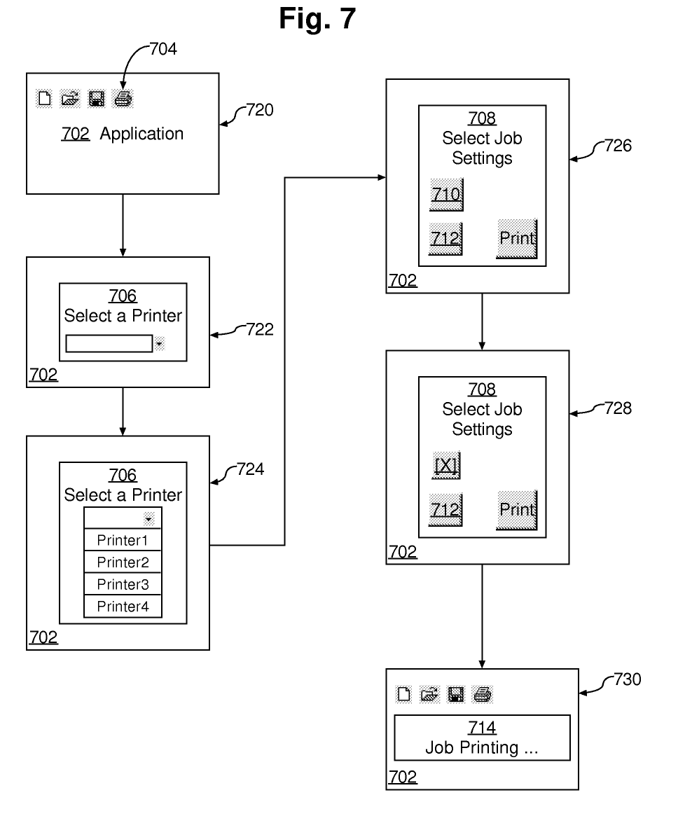

FIG. 7 illustrates example successive screen displays that may be generated during user interaction with a universal device driver. Screen displays 720, 722, 724, 726, 728, 730 represent one example of displays that may be shown during user interaction with an application, driver, and printer using an implementation of the approach of FIG. 6.

For example, screen display 720 shows the user interface of an application 720, such as a word processor. The application 720 displays a toolbar including a Print icon 704 in the user interface of the application. When a user selects the Print icon 704, the device driver causes displaying a generic user interface 706 that includes a drop-down box for selecting a particular printer, as shown in display 722. Assume that the user selects the drop-down box in order to pick a printer. In response, in display 724, the device driver causes displaying a list of printers that are identified, for example purposes, as Printer1, Printer2, Printer3, Printer4. In an embodiment, the device driver generates data for the displays 722, 724 without sending a request to the printer or receiving a user interface description from the printer.

Assume further that the user selects Printer1. In response, as shown in display 726, the generic user interface 706 is removed and the device driver causes displaying a printer user interface 708, which is created after the device driver interacts with the printer to request and receive a description of the user interface. The printer user interface comprises, for example, job setting selection widgets 710, 712 and a Print button.

Assume that the user selects widget 710 and that the widget is a checkbox. In response, the device driver generates and displays an updated display 728 in which widget 710 is checked. Generating the updated display may involve the device driver communicating with the printer to obtain an updated image map or UI description that reflects the user selection of the widget 710. Updated displays may be generated by the device driver repeatedly as needed to respond to user interaction with the user interface.

Assume further that the user selects the Print button in the printer user interface 708. In response, as shown in display 730, the device driver sends job data to the printer and signals the application that printing has begun. The printer can print the job data based on the job settings that were previously determined. In response to receiving a signal from the device driver, the application displays a “Job Printing . . . ” message 714, or similar information, in the application user interface.

The approach of FIG. 4, and the approach of FIG. 5, FIG. 6, and FIG. 7, also may be combined in a hybrid approach. In this alternative, the peripheral device sends the universal device driver a structured document, such as an XML document, providing a user interface description and containing data of an image map file that can embody the user interface. In various embodiments, the image map file may represent all of a user interface panel, or the image map may represent a part of a user interface panel that is relatively static and structured text such as XML may define the elements and appearance of another part of the user interface panel that is relatively dynamic.

Table 3 illustrates an example.

TABLE 3
EXAMPLE UI DESCRIPTION CONTAINING IMAGE

| | |
|---|---|
| <UI> | Dimension = “(0,0) (100,0) (100,100) (0,0)”> |
| | <background type= “img”> http://IP/img/application.jpg size=1024 |
| | [1024 bytes containing binary data for UI_background.jpg] |
| | </background> |

</UI>

Further, in this alternative the UI ticket that the driver sends to the device may be expressed in structured text, such as XML, but may specify coordinate locations of a user selection. Table 4 illustrates an example.

TABLE 4
EXAMPLE UI TICKET CONTAINING COORDINATES

<UITicket

clickLocation = “90,30” >

</UITicket>

In another alternative, user interfaces embodied in image maps may be integrated in a structured text document with an abstraction layer that overlays the image and provides user interface logic associated with the image. In this approach, the device driver maps areas of an image to abstract names of user interface elements. The abstraction layer is used for internal representation only and is not displayed to the user.

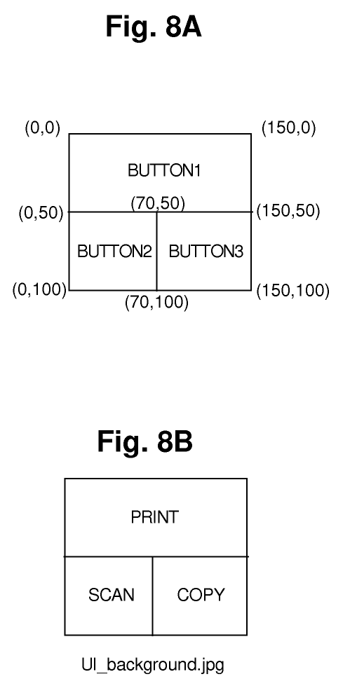

FIG. 8A illustrates an example image map of user interface selection regions. FIG. 8B illustrates an example image map of a user interface for a peripheral device.

Referring first to FIG. 8A, a simplified representation of a user interface for a peripheral device comprises three (3) buttons identified as BUTTON1, BUTTON2, BUTTON3. The labels BUTTON1, BUTTON2, BUTTON3 are expressions of an abstraction layer that may be integrated into a structured text document. Coordinate locations of pixels that form corners of the buttons are also shown in FIG. 8A.

The abstract names represented in FIG. 8A may be displayed, to a user, in the form shown in FIG. 8B. Further, the form of FIG. 8B may be embodied in an image map, such as a BMP, JPG, or GIF file.

Table 5 illustrates an example of structured text that may be used to communicate a description of the user interface of FIG. 8A, 8B from a peripheral device to a device driver, with an abstraction layer, naming the buttons BUTTON1, BUTTON2, BUTTON3 in the image map, integrated into the structure of the description.

TABLE 5
EXAMPLE STRUCTURED TEXT WITH
ABSTRACTION OF UI IMAGE

| <UI | Dimension = “(0,0) (150,0) (150,100) (0,100) (0,0)” |
|---|---|
| | <Background type = “application\|jpg”, size=1024 |
| | [1024 bytes containing binary data for UI_Background.jpg] |
| | </Background> |
| | <Button Name = BUTTON1> |

<location> (0,0) (150,0) (150,50) (0,50) (0,0) </location>

</Button>
<Button Name = BUTTON2>

<location> (0,50) (70,50) (70,100) (0,100) (0,50) </location>

</Button>
<Button Name = BUTTON3>

<location> (70,50) (150,50) (150,100) (70,100) (70,50)

</location>

</Button>

</UI>

Table 6 illustrates an example UI ticket that the device driver may send to the peripheral device to specify that the user clicked on BUTTON1.

TABLE 6
EXAMPLE UI TICKET CONTAINING ABSTRACTION

<UITicket

Clicked = BUTTON1>

</UITicket>

One result of the foregoing approaches is that a user interface is dynamically generated at the time of a request to interact with a peripheral device, based on current device capabilities. The universal device driver can work with any peripheral device that is capable of describing its user interface in response to a request from the driver. No change is required in an application program or the way that a user interacts with the application program. No change is required in the operating system. The user experience is not changed as the user application continues to interoperate with a device driver, namely the universal device driver described herein. However, the user interface with which the user interacts may vary from time to time as the peripheral is updated, but no update to the universal device driver on the host computer is required.

3.0 Hardware Overview

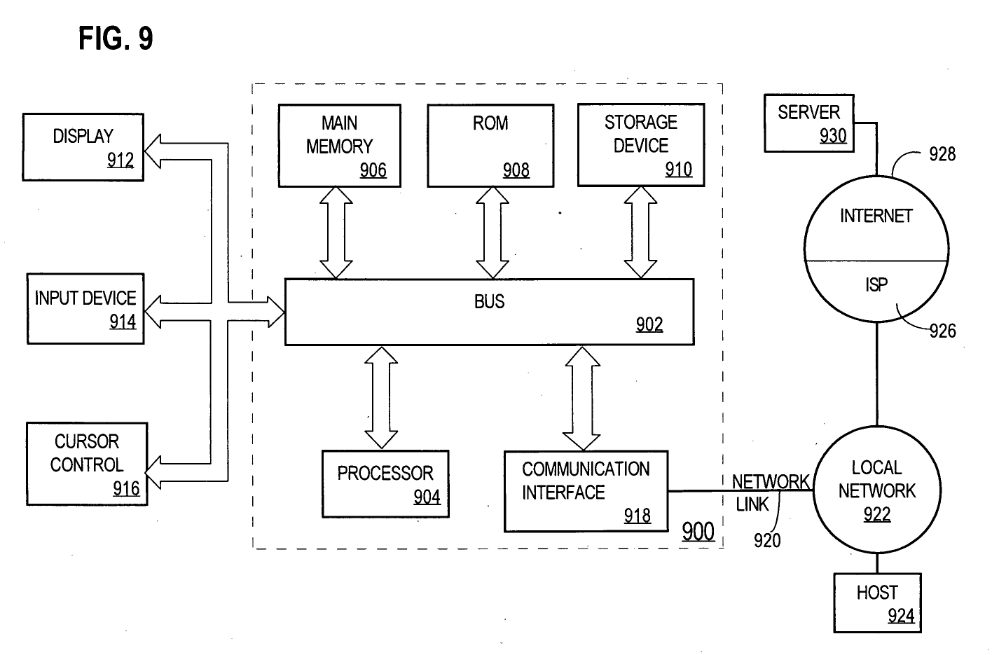

FIG. 9 is a block diagram that illustrates a computer system 900 upon which an embodiment of the invention may be implemented. Computer system 900 includes a bus 902 or other communication mechanism for communicating information, and a processor 904 coupled with bus 902 for processing information. Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

The invention is related to the use of computer system 900 for implementing the techniques described herein. According to one embodiment of the invention, those techniques are performed by computer system 900 in response to processor 904 executing one or more sequences of one or more instructions contained in main memory 906. Such instructions may be read into main memory 906 from another machine-readable medium, such as storage device 910. Execution of the sequences of instructions contained in main memory 906 causes processor 904 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 900, various machine-readable media are involved, for example, in providing instructions to processor 904 for execution. Such a medium may take many forms, including but not limited to storage media and transmission media. Storage media includes both non-volatile media and volatile media. Non-volatile media includes, for example, optical or magnetic disks, such as storage device 910. Volatile media includes dynamic memory, such as main memory 906. Transmission media includes coaxial cables, copper wire and fiber optics, including the wires that comprise bus 902. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 904 for execution. For example, the instructions may initially be carried on a magnetic disk of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are exemplary forms of carrier waves transporting the information.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution. In this manner, computer system 900 may obtain application code in the form of a carrier wave.

4.0 Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer peripheral device driver comprising logic encoded in one or more computer-readable storage media for execution and when executed operable to perform:
sending, from a computer to a peripheral device, a request for a user interface of the peripheral device;
receiving from the peripheral device a description of the user interface that the peripheral device has created in at a time of the request and based upon then-current capabilities of the peripheral device;
creating one or more graphical user interface (GUI) elements based upon the description of the user interface and causing displaying the GUI elements;
receiving user input representing one or more selections of the GUI elements;
creating a user interface ticket that describes the GUI elements that were selected as represented in the user input;
sending the user interface ticket to the peripheral device.

2. The peripheral device driver of claim 1, further comprising logic which when executed causes generating and displaying a list of a plurality of available peripheral devices, receiving second user input representing a selection of one of the available peripheral devices, and sending the request to the selected one of the available peripheral devices represented in the second user input.

3. The peripheral device driver of claim 1, further comprising logic which when executed causes sending to the peripheral device a list of one or more user interface formats that the peripheral device driver may support, and receiving from the peripheral device information identifying a selected one of the user interface formats that the peripheral device supports.

4. The peripheral device driver of claim 1, further comprising logic which when executed causes receiving from the peripheral device the description of the user interface in any of an extensible markup language (XML) stream or file, an image file, an XML stream or file that wraps an image file, or an XML stream or file that references an image file and comprises additional metadata about the image file, XUL format, UIML format, or other format.

5. The peripheral device driver of claim 1, further comprising logic which when executed causes receiving, from the peripheral device, information identifying a user interface format that the peripheral device supports, and storing the information in an entry of a table that associates the information with a copy of the description of the user interface in association with an identifier of the peripheral device.

6. The peripheral device driver of claim 5, further comprising logic which when executed causes performing, only when a time value of the entry has expired, only sending to the peripheral device a request for a new user interface description.

7. The peripheral device driver of claim 1, further comprising logic which when executed causes sending to the peripheral device, separately from the user interface ticket, job data of an application program.

8. The peripheral device driver of claim 1, wherein the peripheral device comprises any of a printer, a multifunction printing device, a scanner, or a finishing machine.

9. The peripheral device driver of claim 1, wherein the description of the user interface comprises an image map and wherein the user interface ticket comprises one or more sets of coordinates.

10. The peripheral device driver of claim 1, further comprising logic which when executed causes performing:
sending, from the computer to the peripheral device, a second request for the user interface of the peripheral device;
receiving from the peripheral device a second description of the user interface that the peripheral device has created in at a second time of the second request and based upon then-current capabilities of the peripheral device, wherein the second description describes a new graphical user interface element for a changed feature of the peripheral device;
creating one or more second graphical user interface (GUI) elements based upon the second description of the user interface and causing displaying the second GUI elements.

11. The peripheral device driver of claim 1, wherein the description of the user interface comprises a first image map, further comprising logic which when executed causes performing:
receiving from the peripheral device a second image map that the peripheral device has created in response to receiving the user interface ticket;
causing displaying the second image map;
receiving second user input representing one or more second selections in the second image map;
creating a second user interface ticket that describes the second selections;
sending the second user interface ticket to the peripheral device;
repeating the preceding steps until a final user interface selection is made.

12. An apparatus, comprising:
one or more processors;
logic encoded in one or more computer-readable storage media for execution and coupled to the one or more processors and when executed operable to perform:
sending, from a computer to a peripheral device, a request for a user interface of the peripheral device;
receiving from the peripheral device a description of the user interface that the peripheral device has created in at a time of the request and based upon then-current capabilities of the peripheral device;
creating one or more graphical user interface (GUI) elements based upon the description of the user interface and causing displaying the GUI elements;
receiving user input representing one or more selections of the GUI elements;
creating a user interface ticket that describes the GUI elements that were selected as represented in the user input;
sending the user interface ticket to the peripheral device.

13. The apparatus of claim 12, further comprising logic which when executed causes generating and displaying a list of a plurality of available peripheral devices, receiving second user input representing a selection of one of the available peripheral devices, and sending the request to the selected one of the available peripheral devices represented in the second user input.

14. The apparatus of claim 12, further comprising logic which when executed causes sending to the peripheral device a list of one or more user interface formats that the peripheral device driver may support, and receiving from the peripheral device information identifying a selected one of the user interface formats that the peripheral device supports.

15. The apparatus of claim 12, further comprising logic which when executed causes receiving from the peripheral device the description of the user interface in any of an extensible markup language (XML) stream or file, an image file, an XML stream or file that wraps an image file, or an XML stream or file that references an image file and comprises additional metadata about the image file, an XUL format file, a UIML format file, or other format file.

16. The apparatus of claim 12, further comprising logic which when executed causes receiving, from the peripheral device, information identifying a user interface format that the peripheral device supports, and storing the information in an entry of a table that associates the information with a copy of the description of the user interface in association with an identifier of the peripheral device.

17. The apparatus of claim 16, further comprising logic which when executed causes performing, only when a time value of the entry has expired, sending to the peripheral device a list of one or more user interface formats that the peripheral device driver may support, and receiving from the peripheral device information identifying a selected one of the user interface formats that the peripheral device supports.

18. A computer-implemented method, comprising:
sending, from a computer to a peripheral device, a request for a user interface of the peripheral device;
receiving from the peripheral device a description of the user interface that the peripheral device has created in at a time of the request and based upon then-current capabilities of the peripheral device;
creating one or more graphical user interface (GUI) elements based upon the description of the user interface and causing displaying the GUI elements;
receiving user input representing one or more selections of the GUI elements;
creating a user interface ticket that describes the GUI elements that were selected as represented in the user input;
sending the user interface ticket to the peripheral device.

19. The method of claim 18, further comprising generating and displaying a list of a plurality of available peripheral devices, receiving second user input representing a selection of one of the available peripheral devices, and sending the request to the selected one of the available peripheral devices represented in the second user input.

20. The method of claim 18, further comprising sending to the peripheral device a list of one or more user interface formats that the peripheral device driver may support, and receiving from the peripheral device information identifying a selected one of the user interface formats that the peripheral device supports.
